(19) United States
(12) Patent Application Publication
(10) Pub. No.: US 2014/0304583 A1
(43) Pub. Date: Oct. 9, 2014

(54) Systems and Methods for Creating Web Pages Based on User Modification of Rich Internet Application Content

(71) Applicant: Jason Fabbri, Roseville, CA (US)

(72) Inventor: Jason Fabbri, Roseville, CA (US)

(73) Assignee: Adobe Systems Incorporated, San Jose, CA (US)

(21) Appl. No.: 12/124,908

(22) Filed: May 21, 2008

(51) Int. Cl. G06F 3/14

(52) U.S. Cl. 715/234

(57) ABSTRACT

Systems and methods for creating web pages based on user modification of rich internet application content are disclosed. For example, one disclosed method includes the steps of receiving an indication of a modification of dynamic content in a rich internet application; modifying the dynamic content based at least in part on the indication; and determining a subset of the dynamic content to be included in a wrapper web page, the subset including modified dynamic content. The method further includes the steps of generating the wrapper web page based at least upon the subset of the dynamic content; and outputting the wrapper web page

### FIELD

The present disclosure relates to generating web pages, and more specifically relates to systems and methods for creating web pages based on user modification of rich internet application content.

### BACKGROUND

Since first becoming publicly available, the Internet and the World Wide Web have evolved dramatically. Web pages were initially available only with text, or text and images, and were typically hand-coded in Hypertext Markup Language (HTML) to be parsed and displayed by a web browser. In such early web pages, most or all of the content of the web page was explicitly recited within the HTML document, and was simply formatted for display by the web browser. With such pages, it was relatively simple for a search engine to extract information from web pages based on an examination of the web pages' source code. However, web pages have become increasingly more complex, and frequently do not explicitly include all of the coding behind all of the content displayed when a user views the web page. In particular, coding for rich internet applications (RIAs) may not be included within the web page, but instead may be loaded by a playback routine from a remote server.

As such, performing searches on RIAs can be difficult as there may be no effective way to search the content of the RIA at a practical rate. Therefore, it may be desirable to include within a web page, such as within the HTML coding, information that describes some or all of the content within a RIA incorporated into the web page.

### SUMMARY

Embodiments disclosed provide systems and methods for creating web pages based on user modification of rich internet application content. For example, one embodiment comprises a method having the steps of receiving an indication of a modification of dynamic content in a rich internet application; modifying the dynamic content based at least in part on the indication; and determining a subset of the dynamic content to be included in a wrapper web page, the subset including modified dynamic content. The method further includes the steps of generating the wrapper web page based at least upon the subset of the dynamic content; and outputting the wrapper web page. In another embodiment, a computer-readable media comprises code for a carrying out such a method.

These illustrative embodiments are mentioned not to limit the disclosure, but to provide examples to aid understanding thereof. Illustrative embodiments are discussed in the Detailed Description, and further description is provided there. Advantages offered by various embodiments may be further understood by examining this specification

### BRIEF DESCRIPTION OF THE DRAWINGS

These and other features, aspects, and advantages of the present disclosure are better understood when the following Detailed Description is read with reference to the accompanying drawings, wherein:

FIG. 1 shows a rich internet application within a web page according to one embodiment;

FIG. 2 shows a Top 10 list from the rich internet application of FIG. 1 according to one embodiment;

FIG. 3 shows a flowchart of a method according to one embodiment;

FIG. 4 shows an HTML wrapper web page generated by one embodiment based on the Top 10 list from the rich internet application of FIG. 1; and

FIGS. 5 and 6 show flowcharts of methods for creating a web page based on user modification of rich internet application content according to some embodiments.

### DETAILED DESCRIPTION

This disclosure describes systems and methods for creating web pages based on user modification of rich internet application content.

### Rich Internet Applications

A rich internet application (RIA) typically is a collection of content that is wrapped within programming code to be executed by a playback routine. For example, some rich internet applications may have an Shockwave Flash (SWF) format and may comprise animations, interfaces, games, and/or other interactive or passive content. Other types of RIA formats include javascript and ActiveX®. Still further types of RIAs would be known to those of skill in the art. In addition, the RIA typically includes program code to instruct a playback routine (referred to as a “RIA player”) how to display and progress through the content within the RIA. For example, Adobe® Flash™ is one type of RIA player, while the open-source Gnash software is another type of RIA player. However, other varieties of RIAs and RIA players are available or may become available.

A very simple RIA may comprise a single animation that begins at its first frame, runs through to the last frame, and exits. More complex RIAs may comprise a plurality of animations, user interfaces, and interactive games.

### Illustrative Creating Web Pages Based on User Modification of Rich Internet Application Content

Many modern web sites incorporate rich internet application into the content available on the web site, such as Adobe® Flash™ animations or games. To catalog content within a RIA for later searching, a system may generate a web page “wrapper” for one or more RIAs available on a web site. A wrapper web page usually comprises a small amount of HTML code, typically enough to allow a web browser to execute the RIA embedded within the web page. The wrapper web page may also include metadata tags to provide some information about the content within the RIA.

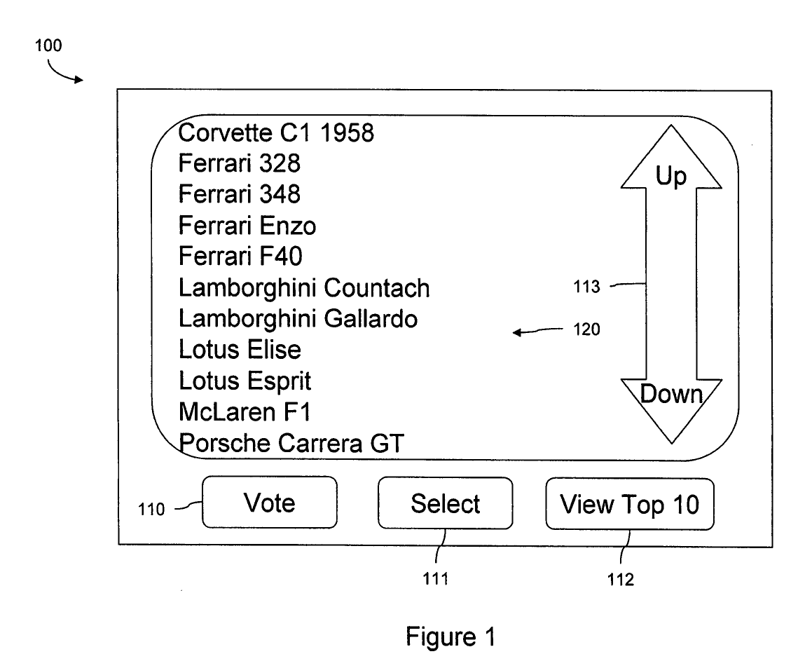

For example, FIG. 1 shows a rich internet application within a web page according to one embodiment. The RIA 100 shown in FIG. 1 is part of a web site for a car club that allows visitors to the site to search the cars owned by the members of the car club and to vote for their favorite car. The RIA includes a dynamically generated “Top 10” list of the ten most popular cars based on votes by the visitors to the site. Because the cars in the “Top 10” list may change based on votes cast over time, the web site's administrator may desire to reflect changes in the ranking within the possible search terms catalogued for the web site.

As can be seen in FIG. 1, a user may scroll through a list of cars 120 using the scroll bar 113, click the “Select” button 111 to select a car, and then click the “Vote” button 110 to vote for it. The user can also select a button 112 to view the Top 10 cars.

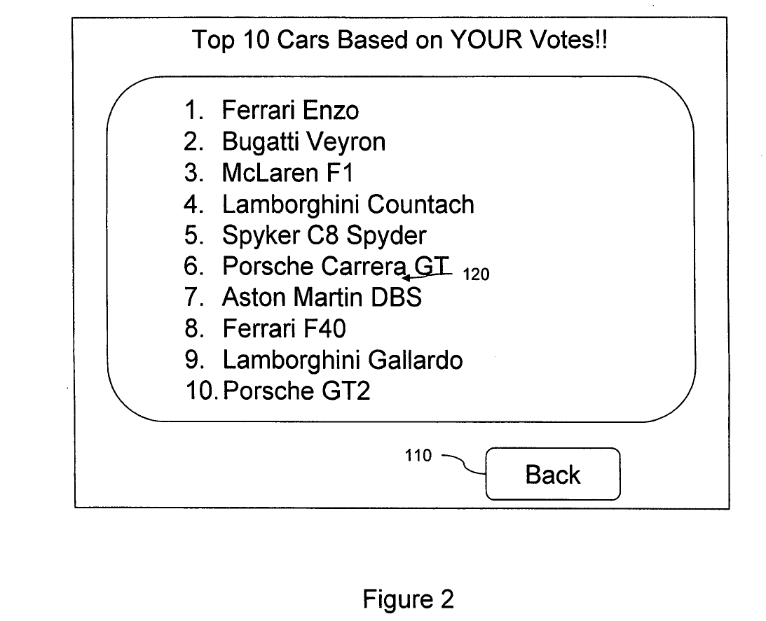

FIG. 2 shows a Top 10 list from the rich internet application of FIG. 1 according to one embodiment. The Top 10 list 120 is displayed by the RIA based on data generated from user votes. Thus, as users vote for different cars by selecting a car and clicking the “Vote” button 110, the ranking of the cars by the RIA may change, and consequently, the Top 10 list 120 will change.

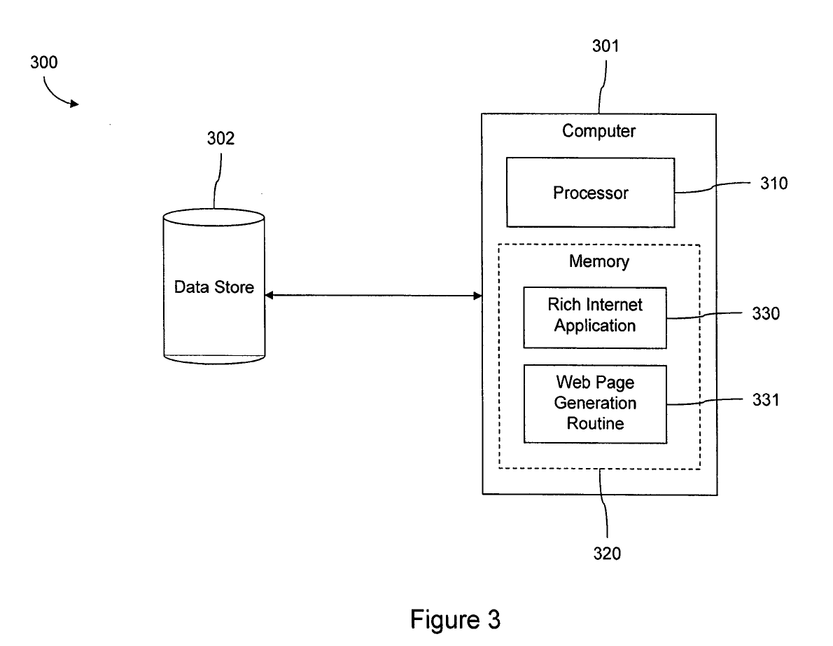

Referring now to FIG. 3, FIG. 3 shows a system 300 for creating web pages based on user modification of rich internet application content according to one embodiment. The system 300 comprises a computer 301 having a processor 310 and a memory 320. Within the memory, the computer has a RIA 330 and a web page generation routine 331. The computer 301 is in communication with a data store 302.

In one embodiment, the web page generation routine 331 is configured to parse the RIA 330 and to request dynamic content from a data store 302. For example, in one embodiment, the RIA 330 comprises the RIA 100 shown in FIGS. 1 and 2. In such an embodiment, the RIA 330 comprises a Top 10 list having dynamic content. Over the course of a day, the types of cars, and their arrangement within the Top 10 list may change. To ensure that the web page is properly indexed by one or more web search engines, the processor may execute the web page generation routine 331 to extract dynamic and static content from the RIA 330.

The web page generation routine 331 may examine the source code for the RIA 330 and extract text information from the RIA 330. For example, in one embodiment, the web page generation routine 331 identifies the “Title” of the RIA 330 and extracts the Title to include in the wrapper web page. For example, in one embodiment, the web page generation routine requests the title from the data store 302. In another embodiment, the web page generation routine re-uses the title from a previous version of the wrapper web page, such as by appending additional material to the previous version of the wrapper web page. In a further embodiment, the web page generation routine identifies a “Title” field or parameter within the RIA and extracts text associated with the field or parameter.

The web page generation routine 331 also identifies data stored outside of the RIA (referred to as “external data”), such as data stored in a data store 302. For example, the ten most popular cars may not be stored within the source code for the RIA 330. Instead, all of the information about the cars, such as make and model, as well as their vote totals, may be stored in the data store 302. As such, the web page generation routine may then request the external data. The web page generation routine may identify external data to request based on the source code within RIA 330. For example, in one embodiment, the web page generation routing may identify fields within the RIA 330 that are associated with data stored in the data store 302. In another embodiment, the web page generation routine may identify source code to request data from a data store. For example, the web page generation routine 331 may identify or generate Search Query Language (SQL) statements configured to request data from a relational database. The web page generation routine 331 may execute such SQL statements to request data from the data store 302.

In one embodiment, the web page generation routine 331 may identify external data based on settings configured by an administrator of the web page generation routine 331. For example, the administrator may configure the web page generation routine 331 to request external data from a data store 302, such as by specifying the location of data to be requested, or by specifying code, such as SQL statements, that the web page generation routine 331 should execute.

The web page generation routine is also configured to generate a wrapper web page. For example, in one embodiment, the web page generation routine 331 is configured to generate a wrapper web page comprising HTML code. The web page comprises HTML code configured to cause a web browser to attempt to load and/or execute a RIA. The web page generation routine 331 also includes at least one HTML metadata tag. The metadata tag comprises at least one data item that has been requested from a data store 302 and that is modifiable based on user input to the RIA 330. For example, in the embodiment shown in FIG. 2, a metadata tag may comprise the make and model of at least one of the cars in the Top 10 list.

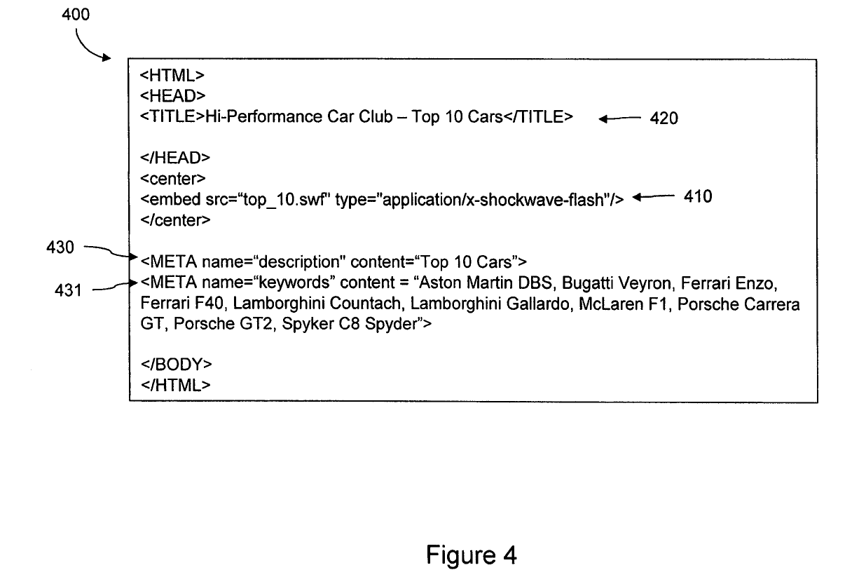

FIG. 4 shows an HTML wrapper web page 400 generated by one embodiment based on the Top 10 list from the rich internet application of FIG. 1. The wrapper web page 400 shown in FIG. 4 comprises a reference 410 to a rich internet application. The reference 410 may cause a web browser to attempt to load and execute the RIA. The wrapper web page 400 also comprises two metadata tags 430, 431 comprising information associated with the Top 10 list. In the embodiment shown in FIG. 4, the web page generation routine 330 determined external data to request from a data store based on the RIA 330, requested the external data, and incorporated it into a metadata tag 431 the wrapper web page 400. Additionally, the web page generation routine identified content from a field within the RIA 330. In the embodiment shown in FIG. 4, the web page generation routine identified a “Title” field within the RIA 330, extracted text data from the “Title” field, and incorporated the title data into the wrapper web page. In the embodiment shown in FIG. 4, the web page generation routine incorporated the title data into the <TITLE> field of the wrapper web page. Alternatively, the web generation routine could incorporate text fields from the RIA 330 into other fields in a wrapper web page.

For example, in one embodiment, a web page generation routine 331 may be configured to generate a wrapper web page comprising external data, wherein the external data is incorporated into fields that may be displayed by a web browser. For example, the web page generation routine may create a wrapper web page comprising a field configured to cause a browser to load and execute a RIA, and may also comprise a field configured to cause a browser to display the external data if the browser cannot load and execute the RIA. In such an embodiment, a wrapper web page may allow a visitor to the web page to view, for example, the Top 10 list even if the user's web browser is not capable of loading and executing the RIA. For example, in one embodiment, a mobile device, such as a cell phone or personal digital assistant, may have a web browser that cannot execute a RIA within a wrapper web page. In such a case, the mobile device's web browser may transmit an indication that the web browser is not configured to execute the RIA. The mobile device then receives the wrapper web page, including the external data, but does not receive the RIA. Such an embodiment may also allow a search engine to properly index the web page to be included in later search results.

In the foregoing embodiments, the web page generation routine has been described as generating HTML-based web pages. However, it should be apparent to one of ordinary skill in the art that embodiments may generate wrapper web pages using other coding types, including eXtensible Markup Language (XML) or javascript.

In the embodiment shown in FIG. 3, data store 302 comprises a relational database. In other embodiments, data store 302 may comprises other types of volatile or non-volatile data storage. For example, data store 302 may comprise a hard disk, a CD-ROM or other optical disk, a flash drive, or other computer-readable medium described later in this application. In one embodiment, data store 302 may comprise a volatile data store within another computer. For example, data store 302 may comprise data stored in RAM on a server remote from the computer 301. In other embodiments, data store 302 may comprise other types of data storage, including databases, computer-readable media, or flat files.

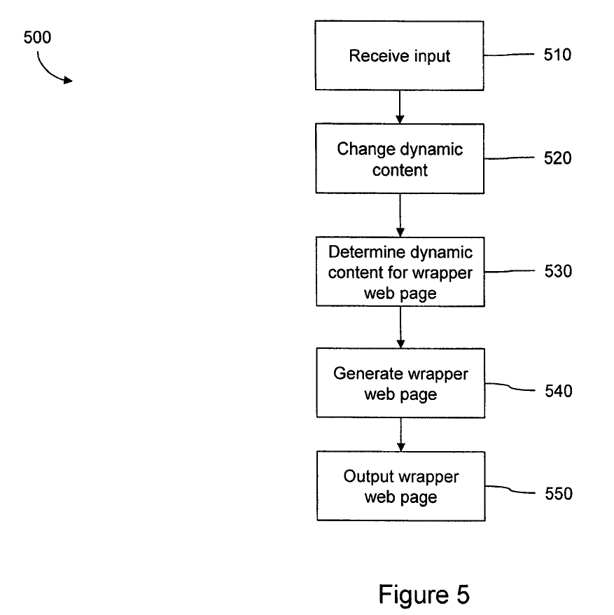

Referring now to FIG. 5, FIG. 5 shows a flowchart of a method 500 for creating a web page based on user modification of rich internet application content according to one embodiment. The description of FIG. 5 will be given with reference to the system 300 shown in FIG. 3.

In the embodiment shown, the method 500 begins when a computer 301 receives an indication of a modification of dynamic content in a rich internet application 510. In one embodiment, receiving an indication may comprise receiving a signal or message over a network indicating that a viewer of a web site has input data to the RIA. For example, in the embodiment shown in FIG. 1, the indication may comprise a TCP/IP message with information associated with the viewer voting for one of the cars on the web page. In this embodiment, the dynamic content comprises the list of cars on the web site as well as the Top 10 list of cars determined by user votes. When the user selects a car and clicks the “Vote” button 110, the RIA transmits a message to a computer 301, such as a web server, indicating that the user has made a vote for the selected car. The computer 301 may then add the vote to a vote count for the car stored in a data store, such as data store 302. The computer 301 may then determine whether Top 10 list of cars should be changed based at least in part on the new vote total for the car the viewer voted for. If the vote caused the car to move into the Top 10 list, or to change positions on the Top 10 list, the computer 301 may adjust data describing the Top 10 list in the data store 302. Thus, the indication received indicates a modification of dynamic content in the RIA. In this embodiment, the modification may be considered indirect, because the dynamic content may or may not change based on the viewer's vote, depending on whether the vote caused the car to change position on the Top 10 list. In some embodiments, an indication may directly cause a modification of dynamic content.

For example, in one embodiment, a user may access a web page comprising a RIA. In this embodiment, the RIA comprises an online community where each member of the community is allocated an individual photo album and a customizable web page on which a user may include personal information. A user may access the RIA by navigating to the community's web site, and by entering a login name and password. Once the user is logged in the user may add one or more pictures to the user's photo album or add or change captions for one or more pictures in the photo album. Further, the user may add or change the personal information in the user's community site. In such an embodiment, the user may transmit files comprising photographs or may transmit messages with new personal information to a computer 301, such as a web server, using the RIA. The computer 301 may then update data within a data store 302 corresponding to the new photos or updated personal information.

In a related embodiment, the user may be able to identify dynamic content to be displayed by a viewer of their personal information. For example, the user may identify one or more data items corresponding to personal information that should not be displayed to a viewer of the user's personal information. In such an embodiment, a user may desire to store their hometown in their personal information, but may elect to keep that information private and not viewable by a visitor to the user's community web site. By marking a data item as private, the RIA transmits a signal to the computer 302, which receives an indication from a user indicating a modification of dynamic content in a RIA.

In the embodiment shown, the method 500 continues when the computer 301 modifies the dynamic content based at least in part on the indication 520. For example, in one embodiment the indication may comprise a message from the RIA to update dynamic content, such as a user's personal information. Upon receiving the indication, a computer 301 may modify dynamic content stored in a data store, such as data store 302. In another embodiment, a computer 301 may receive an indication indicating a modification of dynamic content that causes a change to two or more portions of dynamic content referenced by the RIA. In a further embodiment, the computer 301 may modify dynamic content, which may then require the modification of additional dynamic content. For example, in the embodiment shown in FIGS. 1 and 2, a web server may receive an indication indicating a vote for a car to be in the Top 10. The computer 301 may modify the number of votes in the data store 302 associated with the car. The computer 301 may then determine that the car has achieved a higher rank in the Top 10, and may modify further dynamic content to properly rank the car.

In the embodiment shown, the method 500 continues when the computer 301 determines a subset of the dynamic content to be included in a wrapper web page 530. In one embodiment, the computer 301 determines dynamic content to include in a wrapper web page by including all of the dynamic content in the wrapper web page. For example, a user may maintain a weblog that is published and viewable in a RIA on their website. The RIA is embedded within an wrapper web page that is served by a computer 301 to a visitor's web browser. After the user writes a new log entry and submits the entry to a computer 301 to be published on the weblog, the computer 301 generates a new wrapper web page and includes the text of the new log entry within one or more metadata tags within the wrapper web page. In related embodiment, the computer 301 may include the text of the log entry within the ‘alt’ field of an ‘embed’ or ‘object’ tag within the wrapper web page. Such an embodiment may both allow a search engine to crawl and index the weblog based on the most current log entry, and may also allow a visitor to the web page to view the log entry even if they are not able to execute the RIA to display the log entry.

In another embodiment, the computer 301 may include less than all of the dynamic content in the wrapper web page. For example, in one embodiment, a user may select which dynamic content is publicly viewable. In such an embodiment, the computer 301 may generate a wrapper web page that includes dynamic content that the user has identified as publicly viewable, but does not include dynamic content that the user has not identified as publicly viewable. In another embodiment, the computer 301 may have a configuration file that configures the web page generation routine 331 to only include certain dynamic content, but not other dynamic content. For example, a configuration file may identify one or more fields within a RIA whose data should be included in a wrapper web page. For example, in the embodiment shown in FIG. 1, a configuration file may specify that the data associated with the fields in the Top 10 list should be included in the wrapper web page.

In a related embodiment, a community web site may generate a wrapper web page for each community member's web site. In such an embodiment, the community web site may include a default configuration file that specifies which fields of a user's personal information should be include in the wrapper web page for the user's web site. For example, the default configuration file may specify that a data associated with fields for the user's first name, home town, and birthday are to be included in the wrapper web page. In a related embodiment, a user may be able to modify settings within the configuration file, such as by modifying the file directly, or by selecting fields through an interface in a RIA, to include more information, less information, or different information.

Some embodiments may determine a subset of the dynamic content based on the dynamic content. For example, in one embodiment, a user may submit a weblog entry to be displayed in a RIA. A computer 301 may receive the weblog entry and generate a wrapper web page for the RIA in which the wrapper web page includes the first two sentences of the weblog entry. In a related embodiment, the computer 301 may generate a wrapper web page that includes the first 500 words of the entry.

Step 530 may be performed at different times according to various embodiments. For example, according to one embodiment, determining a subset of the dynamic content to be included in a wrapper web page may occur as a result of modifying the dynamic content. For example, a computer, such as computer 301, may modify the dynamic content, and may then determine dynamic content for the wrapper web page, and may proceed through the remaining steps of the method 500. In another embodiment, determining a subset of the dynamic content to be included in a wrapper web page may occur at a scheduled time. For example, a computer 301, such as a web server, may update a wrapper web page once a day, or every 12 hours. In a further embodiment, step 530 may be initiated manually. For example, an administrator of the web site may cause a web page generation routine 331 to execute to determine a subset of the dynamic content to be included in a wrapper web page

In the embodiment shown, the method 500 continues when the computer 301 generates a wrapper web page based at least upon a subset of the dynamic content 540. In one embodiment, the web page generation routine 330 generates a wrapper web page comprising HTML code that includes an embedded RIA and a metadata tag that includes dynamic content. A wrapper web page may include an embedded RIA by including an HTML tag that instructs a web browser to retrieve a RIA from a computer, such as a web server. For example, a wrapper web page may include an “embed” html tag, or and “object” html tag. In addition, the wrapper web page generator 301 may generate one or more metadata tags within the wrapper web page.

For example, in the embodiment shown in FIGS. 1, 2, and 4, the RIA comprises a list of cars 120 and a list of the top 10 cars. The wrapper web page generator 331 generated a wrapper web page comprising two metadata tags as can be seen in FIG. 4. In one of the metadata tags 430, the wrapper web page generator 331 included a short title to describe some of the dynamic content. In the other metadata tag 431, the wrapper web page generator included each of the cars included in the Top 10 list, which comprises a subset of the dynamic content in the RIA. As can be seen in FIG. 4, the wrapper web page generator 331 is capable of generating metadata tags, as well as fields that are displayed to a viewer of the web page. For example, in the embodiment shown in FIG. 4, the wrapper web page 400 includes a “Title” field, which includes text that may be displayed in the title bar of a user's web browser.

In another embodiment, a web site may comprise a large number of RIAs. For example, a community web site may comprise one or more RIAs per member of the community. In such a case, it may not be desirable to have a wrapper web page for each RIA. Instead, a computer 301, such as a web server, may generate a wrapper web page in response to a request for the RIA. For example, after performing steps 510-530, the computer may not immediately generate the wrapper web page, but may instead wait until the wrapper web page is requested. In such a community, a front page of the web site may allow a visitor to search for a member's web site. When the visitor finds the user's web site and clicks on a link to the web site, the web server may generate the wrapper web page in response to the visitor's request. The web page may then retain a copy of the wrapper web page for some period of time (in case of repeated requests in a short time), before discarding the wrapper web page. Such an embodiment may respond to requests from a search engine by generating wrapper web pages for each member web page requested by the search engine.

In one embodiment, a RIA is configured to generate a wrapper web page for the RIA itself based at least in part on modified content. For example, RIA 330 may comprise the web page generation routine 331 and be configured to execute the web page generation routine 331. In a similar embodiment, a RIA 330 may comprise a web page generation routine 331, and may also present an option to a user of the RIA 330 to generate a wrapper web page. For example, a web site may comprises a RIA 330 that allows a user to modify information in the user's profile that may be visible to other visitors to the web site. After the user has modified their profile information, the user may be presented with an option to publish the profile information. If the user opts to publish the profile information, the RIA 330 executes the web page generation routine 331 to generate a wrapper web page with the updated profile information.

The ability to generate a wrapper web page may be incorporated into the RIA 330 during development. For example, during development of the RIA 330, a user may manually write program code to incorporate the web page generation routine 331.

In another embodiment, a user may select an option within a development environment to automatically incorporate a web page generation routine 331 into the RIA 330. In still a further embodiment, a developer may link a library containing a web page generation routine 331 into the RIA 330 during the process of building the RIA 330.

Alternatively, the RIA 330 may not comprise the web page generation routine 331, but may invoke an external routine to create a wrapper web page. For example, in one embodiment, a RIA 330 may determine that content within the RIA 330 has changed, and that a new wrapper web page should be generated. In such an embodiment, an external process or program may be invoked that is capable of generating the wrapper web page. For example, the RIA 330 may invoke the external routine and pass the modified content to the web page generation routine 331. In another embodiment, the RIA 330 may invoke the external web page generation routine 331, which may then request the modified content from the RIA 330. In a further embodiment, an external web page generation routine 331 may be not be invoked by the RIA 330, but may instead periodically request modified content from the RIA 330 and may generate a wrapper web page if content has been modified, or the external web generation routine 331 may check a specified location, such as a directory on a computer-readable medium, for a RIA 330 having modified content.

In the embodiment shown, the method 500 continues when the computer 301 outputting the wrapper web page. In one embodiment, outputting the wrapper web page comprises storing a file comprising the wrapper web page on a computer-readable medium. For example, the HTML code shown in FIG. 4 maybe stored in a file called “top10.html” on a hard drive of a computer. In another embodiment, outputting the wrapper web page may comprise transmitting a signal comprising the wrapper web page, such as over a network to a user's web browser. In such an embodiment, a web server may receive a request for a web page, and may dynamically generate a wrapper web page and output the web page without storing a permanent copy on a computer readable medium, such as in a file on a hard disk.

Regarding the method 500 shown in FIG. 5, the steps need not be performed in the order shown, and may in fact be performed in virtually any order. For example, a wrapper web page may be generated based on a subset of dynamic content, and output prior to the steps of receiving a modification of dynamic content and changing that dynamic content. Likewise, determining a subset of dynamic content to include in a wrapper web page may occur before any modification of dynamic data is received.

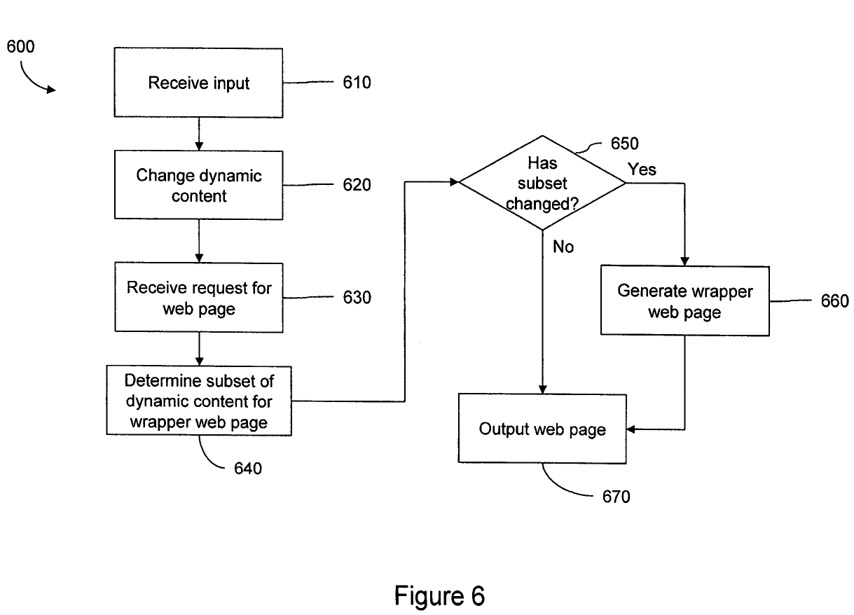

Referring now to FIG. 6, FIG. 6 shows a flowchart of a method for creating a web page based on user modification of rich internet application content according to one embodiment. Steps 610, 620, 640, 660, and 670 generally comprise the steps described above for steps 510-550, respectively.

In the embodiment shown in FIG. 6, the method 600 includes the steps of receiving a request for a wrapper web page and performing a check to determine whether dynamic content used to generate a wrapper web page has changed, but not yet included within a wrapper web page.

In the embodiment shown, the method 600 continues when the computer 301 receives a request for a web page 630. In one embodiment, a request may be received from a web browser. For example, a user may be browsing the Internet and may request a web page comprising a wrapper web page from a computer 301, such as a web server. In another embodiment, the request for the web page may be received from a search engine crawling the World Wide Web. In the embodiment shown in FIG. 6, the receipt of the request, causes the method to move to step 640, where a subset of dynamic content is determined in accordance with the description of step 530 above.

In the embodiment shown, the method 600 continues when the computer 301 determines whether dynamic content included within a wrapper web page has changed 650. In the embodiment shown in FIG. 6, a wrapper web page may already exist. Thus, in one embodiment, it may be desirable to determine whether the dynamic content used to generate the wrapper web page has changed. If the dynamic content has not changed, the method may skip the step of generating the wrapper web page. In another embodiment, it may be desirable to determine if the set of data elements within the subset has changed. For example, a user may have changed a configuration to add or remove a data item from the subset of dynamic content. In such a case, it may be desirable to generate a new wrapper web page. If a change of the dynamic content has occurred, or the number or type of data elements within the subset have changed, the method 600 proceeds to step 660, where a wrapper web page is generated in accordance with the description of step 540 above. However, if a change has not occurred, an existing wrapper web page could be output.

In a related embodiment, the method could move from step 640 immediately to step 660, bypassing step 650. Such an embodiment may be desirable when wrapper web pages are not maintained for some or all RIAs within a web site. For example, as mentioned above, a community web site that provides web pages with one or more RIAs for each of its members may not maintain wrapper web pages for each user. Instead, a wrapper web page may be generated dynamically only when requested.

Referring again to FIG. 3, embodiments can be implemented in digital electronic circuitry, or in computer hardware, firmware, software, or in combinations of them. In one embodiment, a computer 301 may comprise a processor 310 or processors. The processor 310 comprises a computer-readable medium, such as a random access memory (RAM) coupled to the processor. The processor 310 executes computer-executable program instructions stored in memory 320, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable media, that may store instructions that, when executed by the processor, can cause the processor to perform the steps described herein as carried out, or assisted, by a processor. Embodiments of computer-readable media may comprise, but are not limited to, an electronic, optical, magnetic, or other storage or transmission device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other devices may be used, such as a router, private or public network, or other transmission device that comprises some form of computer-readable medium. The processor, and the processing, described may be in one or more structures, and may be dispersed through one or more structures. The processor may comprise code for carrying out one or more of the methods (or parts of methods) described herein.

### General

The foregoing description of embodiments has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

1. A computer-implemented method, comprising:
receiving, by a process executed by a processor in communication with a computer-readable medium, an indication of a modification of dynamic content in a rich internet application (RIA), the RIA associated with a wrapper web page, the wrapper web page comprising a first subset of the dynamic content in a text format;
in response to receiving the indication, determining, by the process, whether the dynamic content has been or should be modified;
in response to determining the dynamic content should be modified, modifying, by the process, the dynamic content based at least in part on the indication;
determining, by the process, a second subset of the dynamic content to be included in a wrapper web page, the subset including modified dynamic content;
modifying, by the process, the wrapper web page to include the second subset of the dynamic content.

2. The computer implemented method of claim 1, further comprising outputting the wrapper web page.

3. The computer-implemented method of claim 1, wherein the rich internet application comprises a Shockwave Flash (SWF) application.

4. The computer-implemented method of claim 1, wherein the indication is received from a user of the rich internet application.

5. The computer-implemented method of claim 1, further comprising requesting the subset of the dynamic content from a data store.

6. The computer-implemented method of claim 1, further comprising receiving a request for the wrapper web page.

7. The computer-implemented method of claim 6, wherein the request is received from a web browser.

8. The computer-implemented method of claim 7, wherein the request comprises an indication that the RIA is not supported by the web browser.

9. The computer-implemented method of claim 8, wherein outputting the wrapper web page does not comprise transmitting the RIA to the web browser.

10. The computer-implemented method of claim 6, wherein the request is received from a search engine.

11. The computer-implemented method of claim 6, wherein the request is received before the step of generating the wrapper web page based at least upon the subset of the dynamic content.

12. The computer-implemented method of claim 1, further comprising determining whether the first subset of the dynamic content has been modified.

13. The computer-implemented method of claim 1, wherein the process is the rich internet application.

14. A non-transitory computer-readable medium on which is encoded program code, comprising:
program code to receive an indication of a modification of dynamic content in a rich internet application (RIA), the RIA associated with a wrapper web page, the wrapper web page comprising a first subset of the dynamic content in a text format;
program code to, in response to receiving the indication, determining whether the dynamic content has been or should be modified;
program code to, in response to determining the dynamic content should modified, modify the dynamic content based at least in part on the indication;
program code to determine a second subset of the dynamic content to be included in a wrapper web page, the subset including modified dynamic content;
program code to modify the wrapper web page to include the second subset of the dynamic content.

15. The non-transitory computer-readable medium of claim 14, further comprising program code to output the wrapper web page.

16. The non-transitory computer-readable medium of claim 14, wherein the rich internet application comprises a Shockwave Flash (SWF) application.

17. The non-transitory computer-readable medium of claim 14, wherein the indication is received from a user of the rich internet application.

18. The non-transitory computer-readable medium of claim 14, further comprising program code to request the subset of the dynamic content from a data store.

19. The non-transitory computer-readable medium of claim 14, further comprising program code to determine whether the subset of the dynamic content has been modified.

20. (canceled)

21. A system, comprising:
a memory comprising a rich internet application; and
a processor in communication with the memory, the processor configured to
receive an indication of a modification of the dynamic content in a rich internet application (RIA), the RIA associated with a wrapper web page, the wrapper web page comprising a first subset of the dynamic content in a text format,
in response to receiving the indication, determine whether the dynamic content has been or should be modified,
in response to determining the dynamic content should be modified, modify the dynamic content based at least in part on the indication,
determine a second subset of the dynamic content to be included in a wrapper web page, the subset including modified dynamic content,
modify the wrapper web page to include the second subset of the dynamic content.

22. The system of claim 21, wherein the processor is further configured to output the wrapper web page.

23. The system of claim 21, further comprising a data store having at least some of the dynamic content, the processor in communication with the data store.

24. The system of claim 21, wherein the processor is further configured to receive a request for the wrapper web page.

25. The system of claim 24, wherein the request is received before the step of generating the wrapper web page based at least upon the subset of the dynamic content.

26. The computer-implemented method of claim 1, further comprising receiving the modified dynamic content, the modified dynamic content received from a viewer of the RIA.

27. The non-transitory computer-readable medium of claim 1, further comprising program code for receiving the modified dynamic content, the modified dynamic content received from a viewer of the RIA.

28. The system of claim 21, wherein the processor is further configured to receive the modified dynamic content, the modified dynamic content received from a viewer of the RIA.
